(19) United States
(12) Patent Application Publication
(10) Pub. No.: US 2012/0100876 A1
(43) Pub. Date: Apr. 26, 2012

(54) HANDS FREE TELEPHONE SYSTEM WITH INTEGRATED TEXT MESSAGING CONFIGURATION

(75) Inventors: Elisabet A. Anderson, Holland, MI (US); William Fay, Rockford, MI (US); Matthew Blackburn, Cedar Springs, MI (US); Alan S. Hughes, Holland, MI (US); Beth A. McGough, Holland, MI (US); Ted W. Ringold, Hudsonville, MI (US)

(73) Assignee: JOHNSON CONTROLS TECHNOLOGY COMPANY, Holland, MI (US)

(21) Appl. No.: 12/908,733

(22) Filed: Oct. 20, 2010

(51) Int. Cl. H04W 4/00

(52) U.S. Cl. 455/466

(57) ABSTRACT

The invention relates to a communication system for in-vehicle systems, and in particular, to a wireless communication system for a hands free telephone system configured to received text messages. A remote source, such as a cell phone, PDA or the like, is used to modify, configure and add new messages and preference data on the communication system. The modified, configured and new messages are used to respond to messages received on the remote source and/or on the communication system.

### TECHNICAL FIELD

This invention relates generally to a communication system for in-vehicle systems, and in particular, to a wireless communication system for a hands free telephone system configured to receive text messages.

### BACKGROUND OF THE INVENTION

Personal electronic devices, such as mobile telephones, personal digital assistants (PDAs), digital music players, electronic gaming devices and the like, are increasingly becoming integrated for use within vehicles. Integration of these various devices is typically handled by a central processor within the vehicle. For example, hands free telephone systems have been developed for vehicles that allow the hands free use of a driver's or passenger's mobile telephone. The ability to transfer information between the hands free telephone system and the user's personal electronic device, in a wireless fashion, increases the ease and convenience of use of such devices when traveling in the vehicle.

### SUMMARY OF THE INVENTION

In general terms, this invention relates to a communication system for in-vehicle systems, and in particular, to a wireless communication system for a hands free telephone system configured to received text messages. A remote source, such as a cell phone, PDA or the like, is used to modify, configure and add new messages and preference data on the communication system. The modified, configured and new messages are used to respond to messages received on the remote source and/or on the communication system.

In one embodiment of the invention, there is a method of modifying data in a communication system of a vehicle, the communication system including a control system and a remote source, the method including pairing the control system and the remote source; sending a message to the remote source including a request to update data stored for use by the control system; receiving a response from the remote source in response to the request electing to update the data in the control system; and updating the data in the control system in accordance with the received response.

In another embodiment of the invention, there is a control system for a vehicle storing data and enabling modification of the stored data using a remote source, including a module to pair the control system with the remote source; and a communication interface sending a message to the remote source including a request to update data stored for use by the control system, and receiving a response from the remote source in response to the request electing to update the data in the control system, wherein the module updates the data in the control system in accordance with the received response.

In one aspect of the invention, the control system: receives a command sent by the remote source initiating modification of data, detects the command and responds to the remote source by sending the message including the request to update data.

In another aspect of the invention, the message sent to the remote source includes a link to the request to update data.

In still another aspect of the invention, accessing the link by the remote source provides an interface for updating the data in the control system.

In another aspect of the invention, the message sent to the remote source includes an application or link to download an application for use by the remote source, and the application provides an interface for updating the data in the control system using the remote source.

In still another aspect of the invention, the remote source is a personal computer connected to the control system via a network, and the personal computer includes software providing an interface for updating the data in the control system.

In yet another aspect of the invention, the message and response is at least one of a text message, picture message, video message, email message and multi-media message.

In a further aspect of the invention, when the remote source receives an SMS or MMS message, the data stored in the control system is selected for replying thereto.

In still a further aspect of the invention, the reply to the SMS or MMS message is automatic.

In yet a further aspect of the invention, communication between the control system and the remote source includes one of: a USB connection, a Bluetooth connection, a Wifi connection, and 802.11 connection, an Internet connection, and a network connection.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is an exemplary embodiment of a vehicle control system.

FIG. 2 is an exemplary embodiment of a vehicle control system having data connections with a variety of remote sources.

FIG. 3 is an exemplary diagram of a vehicle control system having a connection with a vehicle data bus and vehicle modules.

FIG. 4 is an exemplary block diagram of a system for synchronizing data between remote sources and the vehicle control system.

FIG. 5 is an exemplary flow diagram of a method in accordance with the invention.

FIG. 6 is another exemplary flow diagram of a method in accordance with the invention.

FIG. 7 is another exemplary flow diagram of a method in accordance with the invention.

FIG. 8 is another exemplary flow diagram of a method in accordance with the invention.

FIG. 9 is another exemplary flow diagram of a method in accordance with the invention.

FIGS. 10A-10G illustrate exemplary screen shots on a remote source in accordance with an embodiment of the invention.

FIG. 11 is another exemplary flow diagram of a method in accordance with the invention.

### DETAILED DESCRIPTION OF A PREFERRED EMBODIMENT

The invention relates to a communication system for in-vehicle systems, and in particular, to a wireless communication system for a hands free telephone system configured to received text messages.

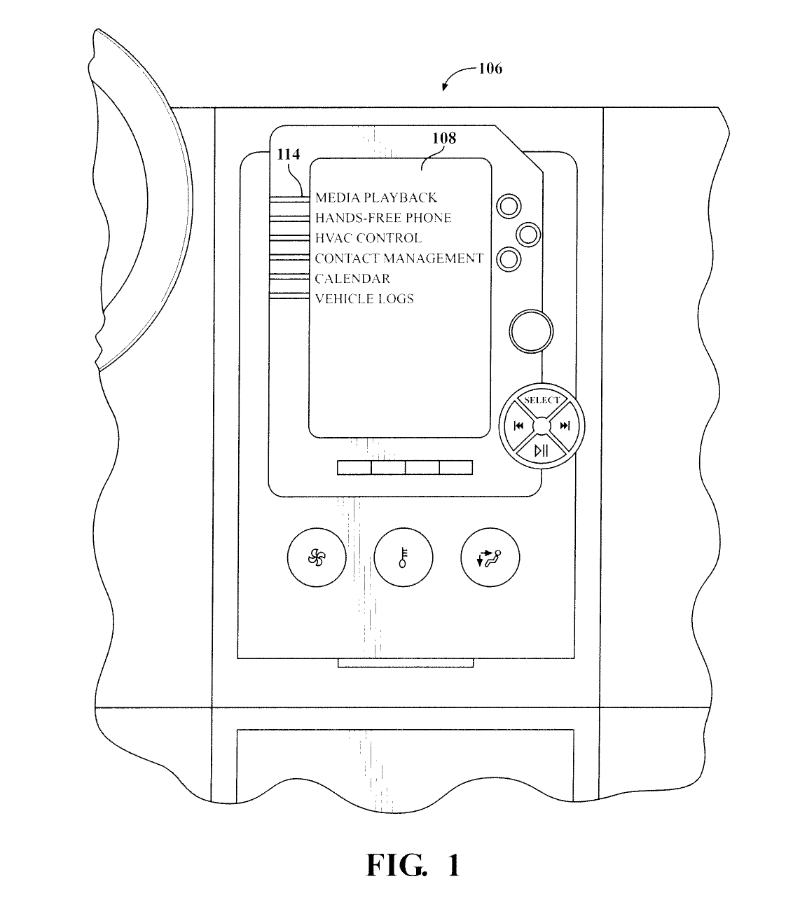

Referring to FIG. 1, an exemplary embodiment of a vehicle control system 106 is shown. Vehicle control system 106 generally includes a display 108 and one or more tactile user inputs or pushbuttons 114, which facilitate controlling various vehicle functions. Display 108 may be configured to display data related to the control of the vehicle functions. In one exemplary embodiment, display 108 may be a touch-screen display, while in other exemplary embodiments, may be any other non-touch sensitive display. In still other exemplary embodiments, display 108 may be of any technology (e.g., LCD, DLP, plasma, CRT), configuration (e.g., portrait or landscape), or shape (e.g., polygonal, curved, curvilinear). The surface of the display may be curved in three dimensions or flat. Display 108 may be a manufacturer installed display, an aftermarket display, or a display from any source. Display 108 may be an embedded display (e.g., a display embedded in the control system or other vehicle systems, parts, or structures), a standalone display (e.g., a portable display, a display mounted on a movable arm), or a display having any other configuration. Pushbuttons 114 may be configured to control a variety of functions including the hands free telephone module or control any other desired vehicle function.

It should be noted that pushbuttons 114 and/or other user interface elements may be reconfigurable. The function of pushbuttons 114, for example, may be reconfigured to match the content on the screen. Accordingly, a user may be able to make selections with pushbuttons 114 specifically relating to an application making use of the display screen. The operation of pushbutton 114 for hands-free telephone operation may display a menu screen or execute commands that allow the user to connect vehicle control system 106 to a mobile phone so that speaking into the vehicle console of vehicle control system 106 operates the mobile phone. Alternatively, the display 108 may cause a menu to appear on the screen which enables a user to control system 106 by selection of menu items.

The operation of pushbuttons 114 for display control may display a menu screen or execute commands that allow the user to input, view, set, select, and/or change display profile settings or display settings such as color, resolution, size, language, tilt, or any other setting or variable by tactile or oral command. The operations of pushbuttons 114 for communications control may display a menu screen or execute commands that allow the user to input, view, select, reset, set, or activate communications settings or communications modes by tactile or oral command. According to various other exemplary embodiments, input from gesture sensors or presence sensors may be provided to vehicle control system to detect something other than touch. The gesture sensors or the presence sensors may be provided in place of tactile controls or in addition to tactile controls.

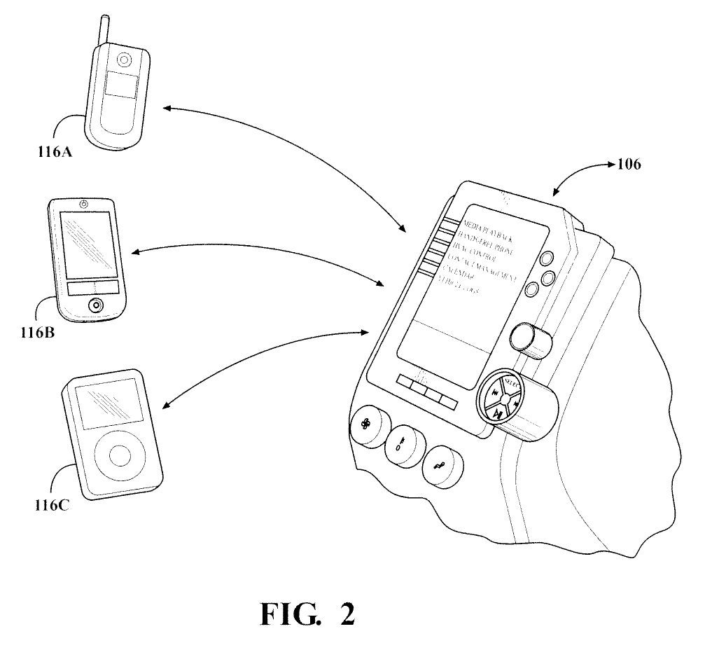

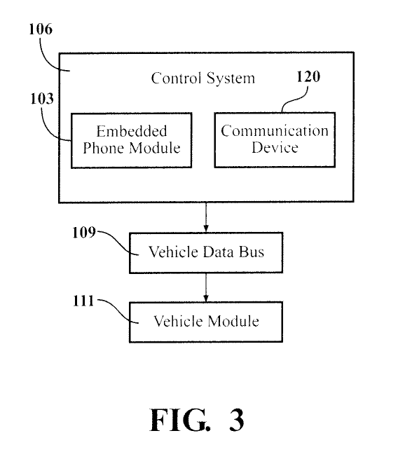

Referring to FIG. 2, according to an exemplary embodiment, control system 106 is shown having data connections with a variety of remote sources. For example, control system 106 may establish a data connection with cellular telephone 116a, a PDA 116b, a media player 116c, etc. Control system 106 may be configured to establish simultaneous data connections with a plurality of remote sources 116 using communications device 120 (See, FIG. 3). For example, control system 106 may establish a simultaneous data connection with mobile telephone 116a and media player 116c. According to various exemplary embodiments, control system 106 may establish simultaneous data connections with any combination and/or number of remote sources. The remote sources may also be controlled by different users. Control system 106 may use a communications device 120 to control the communications between the vehicle control system and a plurality of remote sources. The connected remote sources may transmit data directly to or from the vehicle control system. The vehicle control system may also be used as a network gateway or router and may be configured to route information from one remote source to other remote sources connected to the vehicle control system. Vehicle control system 106 may include any number of hardware and/or software components to implement multiple device connectivity. For example, vehicle control system 106 may have more than one wireless communications device, more than one wired communications device, and/or any number of software drivers, software profiles, and software applications configured to facilitate and control multiple device connectivity.

### Embedded Phone Module/Connected Phone Activity

Referring to FIG. 3, according to an exemplary embodiment, control system 106 is shown having a connection with a vehicle data bus 109. The connection with vehicle data bus 109 may be via an interface module of the control system. The vehicle data bus may be connected to a number of vehicle modules 111. Vehicle data bus 109 may be any electronic communications network that interconnects vehicle components. The modules may be configured to exchange data between themselves via the vehicle data bus 109. The control system 106 may be configured to route information to or from vehicle modules on the vehicle data bus to or from other components of the control system or to or from remote sources. According to various embodiments, vehicle bus 109 may be a vehicle bus of any type or technology. For example, vehicle bus 109 may be a local interconnect network, a controller area network, a FlexRay bus, a Media Oriented System Transport (MOST), a Keyword Protocol 2000 bus, a serial bus, a parallel bus, a Vehicle Area Network, a DC-BUS, a IDB-1394 bus, a SMARTwireX bus, a CAN (e.g., BCAN) bus, an IE bus (e.g., a GA-NET bus), etc. According to various exemplary embodiments, vehicle data bus 109 may be of any past, present or future design capable of providing an electronic communications network that interconnects vehicle hardware components inside a vehicle. Vehicle control system 106 may include any number of hardware interfaces, transceivers, bus controllers, hardware controllers, and/or software controllers configured to control communication activities of the vehicle data buses of the vehicle.

Referring further to FIG. 3, according to an exemplary embodiment, control system 106 may access data of vehicle data bus 109, and further of vehicle hardware modules, to provide features to control system 106 and/or to remote sources 116a-c. It is important to note than any number of enhanced data or control features may be added to control system 106 and/or to connected remote sources 116a-d when control system 106 is capable of serving as a network gateway simultaneously connected to a plurality of remote sources and vehicle hardware modules of a vehicle data bus.

Referring further to FIG. 3, a block diagram of control system 106 coupled to a vehicle module 111 is shown, according to an exemplary embodiment. Control system 106 may include a phone module 103. Phone module 103 may be embedded in the control system 106 or otherwise connected to the vehicle data bus. Phone module 103 may also be configured to accept data from a cellular phone, PDA, or other remote device or source that may connect to control system 106. Control system 106 may connect to vehicle module 1002 via vehicle data link or bus 109, providing vehicle module 111 with data received from phone module 103. The data may include commands or requests regarding various vehicle systems of vehicle module 111. For example, commands may include a request to update data in the phone module 103 or other vehicle modules 111. It is also appreciated that the control system 106 does not have to include a phone module 103. In such a case, the remote source 116a-c can communicate with the control system 106 in order to provide modifications and updates to the system messages.

### Text, Picture and Video Messaging

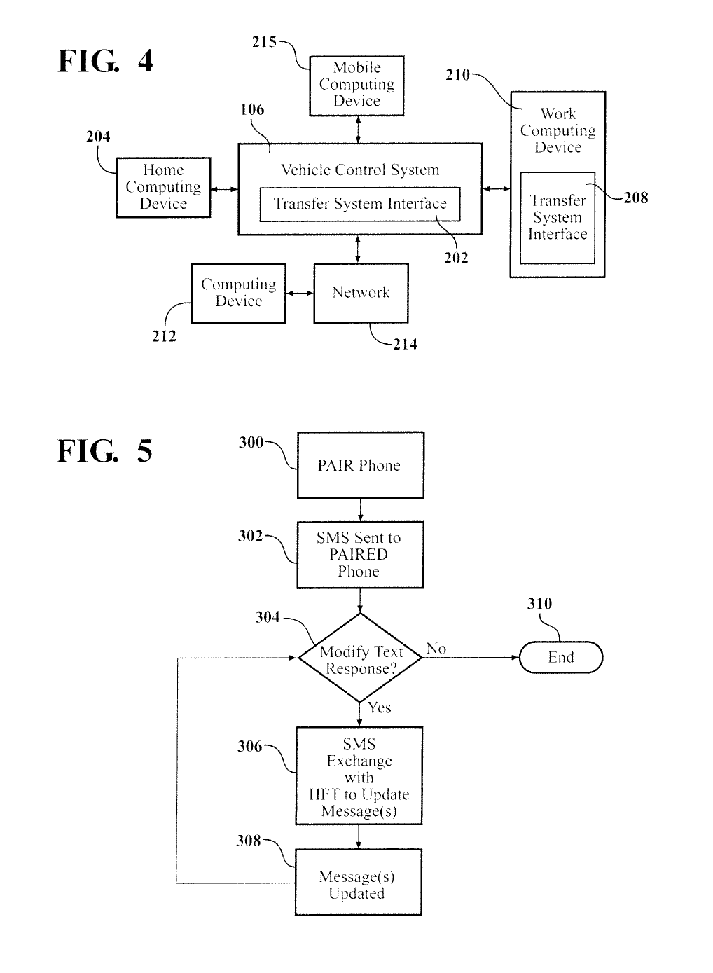

Phone module 103 may be configured to handle a variety of call types and/or communication types. For example, phone module 103 may be configured to place a voice call, send text, picture and/or video messages (e.g., SMS or MMS messages), operate as a modem using a voice call, send and/or receive control channel data, and conduct data calls (e.g., 1xRTT data calls). Furthermore, any of the activities, call types, or communication types of the phone may be originated via logic of the vehicle control system and/or in response to signals received from a remote source at the vehicle control system. Similarly, the activities, call types, or communication types of the phone may be terminated via logic of the vehicle control system and/or in response to signals received from a remote source at the vehicle control system. Additionally, the activities, call types, or communication types of the phone may be managed by one or more software applications of control system 106 or by a connected mobile network, such as network 214 (FIG. 4).

Referring now to FIG. 4, a block diagram of a system for synchronizing and/or transferring text between remote sources and vehicle control system 106 is shown, according to an exemplary embodiment. Vehicle control system 106 may be configured to provide a transfer system interface 202 to a vehicle display system. According to various other exemplary embodiments, vehicle control system 106 may be configured to provide a transfer system interface to a remote source (e.g., home computing device 204) via a web server or another service residing on the vehicle control system. According to yet other exemplary embodiments, a transfer system interface 208 may also or alternatively reside on a remote source (e.g., work computing device 210 or mobile computing device 216).

Computer code residing in memory of control system 106 is configured to facilitate the transfer and/or synchronization of data (e.g. text, picture, video messages) between computing devices 204, 216, 212 (shown connected to vehicle control system 106 via network 214), mobile computing device 216, and/or memory of vehicle control system 106. The transfer system interfaces (e.g., 202, 208) are generally configured to allow a user to control the transfer and/or synchronization of data. According to an exemplary embodiment, the transfer system interface provides the user with an icon for one or more computing devices that may be configured to connect to the vehicle control system and an icon for the vehicle control system. Data may then be transferred between the various sources, either wirelessly or by wired communications and/or using any other known or later-developed storage and/or transport device or system, to the control system.

Referring further to FIG. 4, in embodiments where a remote source includes a transfer system interface (e.g., transfer system interface 208) or where the vehicle control system may remotely (e.g., wirelessly) provide the transfer system interface to the remote source (e.g., computing devices 212, 216, 204), the transfer system interface may then be configured to facilitate the transfer of data from the remote source to the vehicle control system. Transferring data (e.g., text) from the remote source to the vehicle control system allows the user to update data in the vehicle system, and allows the user to use control system 106 as a display. Once data is received by the vehicle control system, the control system may be configured to prepare the files for display, audio playback, and/or selection by the user. For example, when the vehicle control system powers-up, the vehicle control system may display recently received data to the user via a display system for selection. According to various exemplary embodiments, the user can access the received data through a variety of commands (e.g., tactile commands and/or voice commands). The user may request that the system read aloud a selected text file, where the selected text file is, for example, an e-mail message, an SMS message, etc. The system may also be configured to read other data (e.g., media files, etc.). Once selected, the vehicle control system may be configured to convert the text of the selected text file into an audio signal. The signal can be output directly to the audio system and played for the user.

### Updating and Modifying System Stored Messages

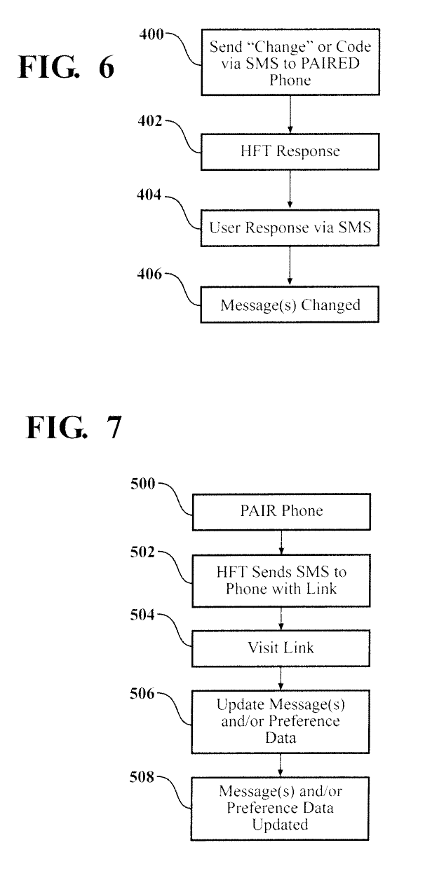

Referring to FIG. 5, is an exemplary flow diagram of a method in accordance with the invention. In order for a remote source 116a-c to communicate with control system 106, it must be paired with the system. Pairing of a remote source 116a-c with control system 106 may be accomplished by any known method in the art. For example, if remote source 116a is a cell phone that requires connection via Bluetooth™, the device is placed into discoverable mode and the phone module (hands free telephone module or HFT module) 103 of the control system 106 of the vehicle searches for the device. Once located, the device accepts the connection from the control system, creating a wireless link between the two. It is understood, however, that any method of connection (wired or wireless) may be used, and the connection of devices to the vehicle is not limited to the described example. Again, it is appreciated that while an HFT module 103 is used in the preferred embodiment, the system is not limited to instances where an HFT module exists. Other alternative methods of connecting to the vehicle control system may be used as readily understood in the art.

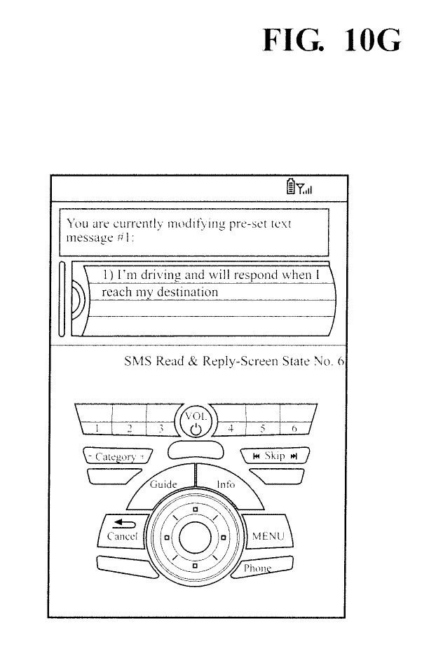

In this embodiment, the control system 106 is set to send a message to a remote device upon pairing (e.g. upon entering and activating the vehicle when the remote source is activated). Pairing, in this example, is accomplished using phone module 103 of control system 106. Upon completion of paring the remote source 116a-c with the control system 106 in step 300, a message (e.g. email, text, picture, video message, etc.) is sent by the control system 106 and received by the remote source at 302. An exemplary message that might appear on the remote device 116a-c is illustrated in FIG. 10A. Here, the received message indicates that the remote source 116a-c has successfully paired with the phone module 103 of control system 106, and provides instructions for responding. For example, a reply message may be sent back to the control system 106, or a web page may be visited to update a message and/or other user preferences (e.g. enable/disable new message notification, SMS system, automatic message download, automatic text-to-speech, etc.) If the user opts not to modify or update the existing messages, the method ends at step 310. Otherwise, the user responds in step 304 with an election to modify the message. For example, the word “change” may be sent from the remote source 116a-c back to the control system 106, as illustrated in FIG. 10B. Step 306 is an exchange of messages between the remote source 116a-c and the control system 106 to select which message to modify, or add a new message, as illustrated in FIG. 10C. In the described embodiment, the user has elected to modify pre-set response #1, as illustrated in FIG. 10D. FIG. 10E shows the currently available message associated with pre-set #1. Upon entry of the modified message, and confirmation by the control system 106, the message is updated in the system at 308, as illustrated in FIG. 10G.

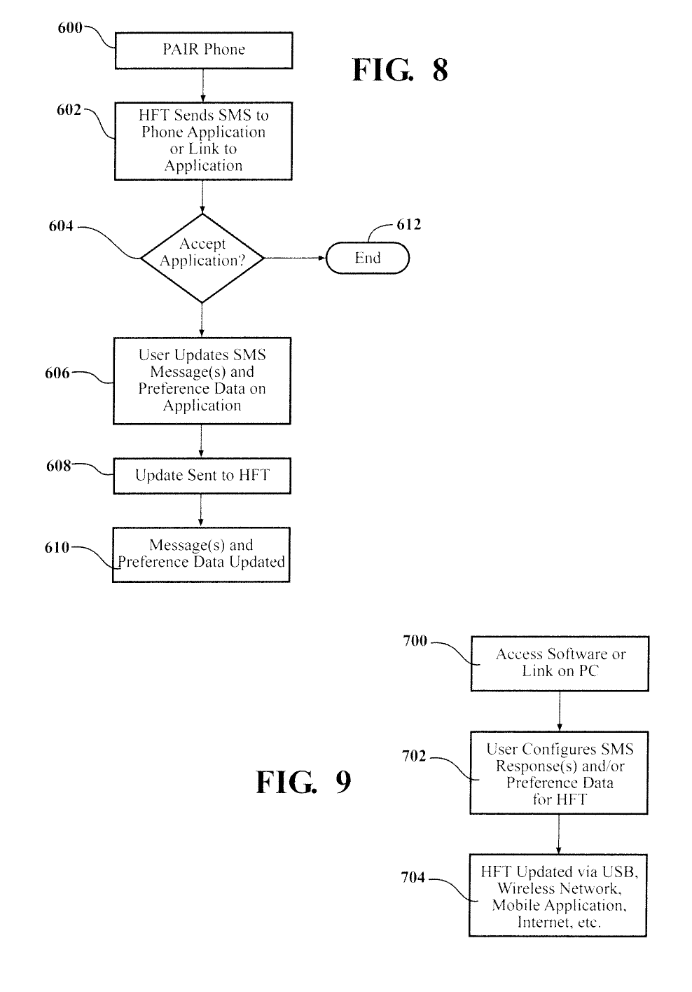

In another embodiment, a user may elect to modify or add new messages after completion of pairing with the remote source. FIG. 6 is an exemplary flow diagram of another method in accordance with the invention. The user initiates the method in step 400 by sending a message (e.g. a text message) from the paired remote source 116a-c to the phone module 103 embedded in control system 106. The message may include a word, such as “change,” or a code or name specifically associated with the remote source which is recognizable by the phone module 103. For example, the phone module could send the remote source a text message with a specific device name (e.g. BTConfig8231). The user could change the name of the remote source to the specific device name and sends one or more messages including the modified or new messages. When the phone module detects the messages from the device having the specific device name, the phone module parses and stores the new configuration item(s). Upon ignition cycle, the phone module would send the new list of messages and/or other configuration items to the remote source and the phone module would no longer received modified of new messages from the device. Alternatively, the phone module could send a code (e.g. ZXKP3291) to the paired device. The user would then include that code in the message when sending modified or new messages to the phone module, which module would recognize the code and perform the requested action. After initiating the request in step 400, the control system 106 responds to the request in step 402, the user responds to the control system in 404, and the message(s) are modified and/or added in 406, similar to the method explained with reference to steps 304, 306 and 308 of FIG. 5. The details of which are not repeated.

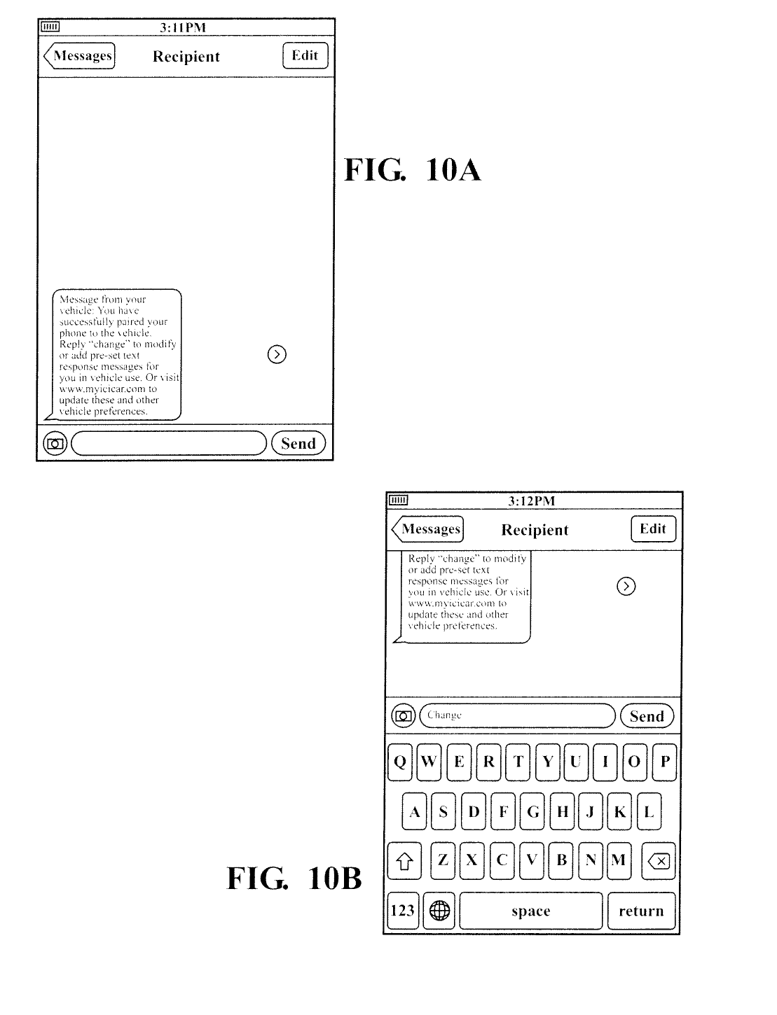

In another embodiment, a user may elect to modify or add new messages using a website. The website may be accessed, for example, via a personal computer, remote source (such as a cell phone or PDA), or any other know method. FIG. 7 is an exemplary flow diagram of another method in accordance with the invention. Upon pairing the remote source 116a-c with the phone module 103 in control system 106 in step 500, the control system 106 sends a message to the remote source 116a-c in step 502, which message includes a link or web address. The user selects the link (or enters the address into a browser) on the remote source 116a-c at step 504, and the web page associated with the link or address is opened. The web page may automatically recognize (i.e. verify) the remote source and vehicle, or information may need to be input by the user in order to be granted access to the web page. Once access is granted, the user may modify and/or add new messages, as well as other preference data, via the web site at step 506. In one example of the embodiment, the updated data is then sent from the remote source, such as mobile computing device 216, via communications device 120, to control system 106. Once received at the control system 106, the message(s) and/or preference data is updated at step 508. It is appreciated that modification and/or addition of messages occurs similar to the method described above with respect to steps 304-308, although using web pages, browsers and/or network connections as opposed to text messages.

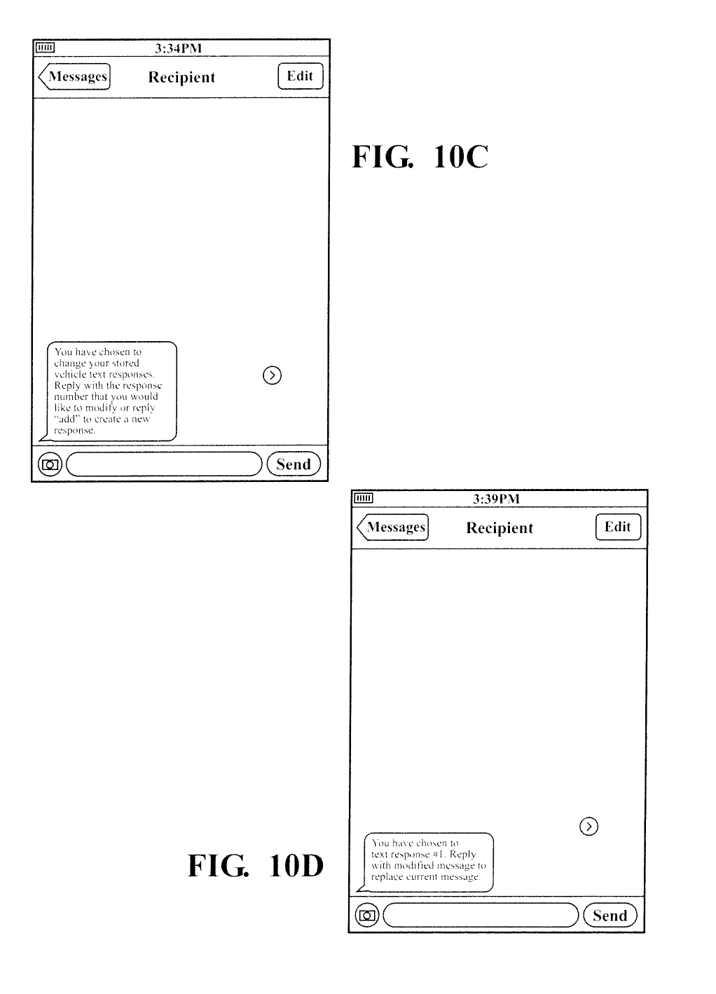

FIG. 8 illustrates an exemplary flow chart of still another method in accordance with the invention. In this embodiment, a mobile application on the remote source is used to modify and/or add new messages to the control system 106. An exemplary interface of the mobile application is illustrated in FIGS. 10E and 10G. It is understood that these interfaces are exemplary in nature, and the invention is not limited to these specific embodiments. The mobile application interface may take the shape and form of any interface as readily understood in the art. In step 600, the remote source 116a-c is paired with the phone module 103 of control system 106. The control module 106 sends an application or link to an application for download to the remote source 116a-c in step 602, and the user elects to accept or deny the application in step 604. If the user denies the application, the method ends at step 612. Otherwise, the application is accepted and run or downloaded onto the remote source 116a-c for use. The mobile application, similar to the web page embodiment, enables the user to modify and/or add new messages or preference data to the control system 106. As shown in FIGS. 10E and 10G, the user may input data using the remote source at step 606. The input (modified or new data) is the sent to the control system 106 in step 608, and the data is updated/modified in step 610.

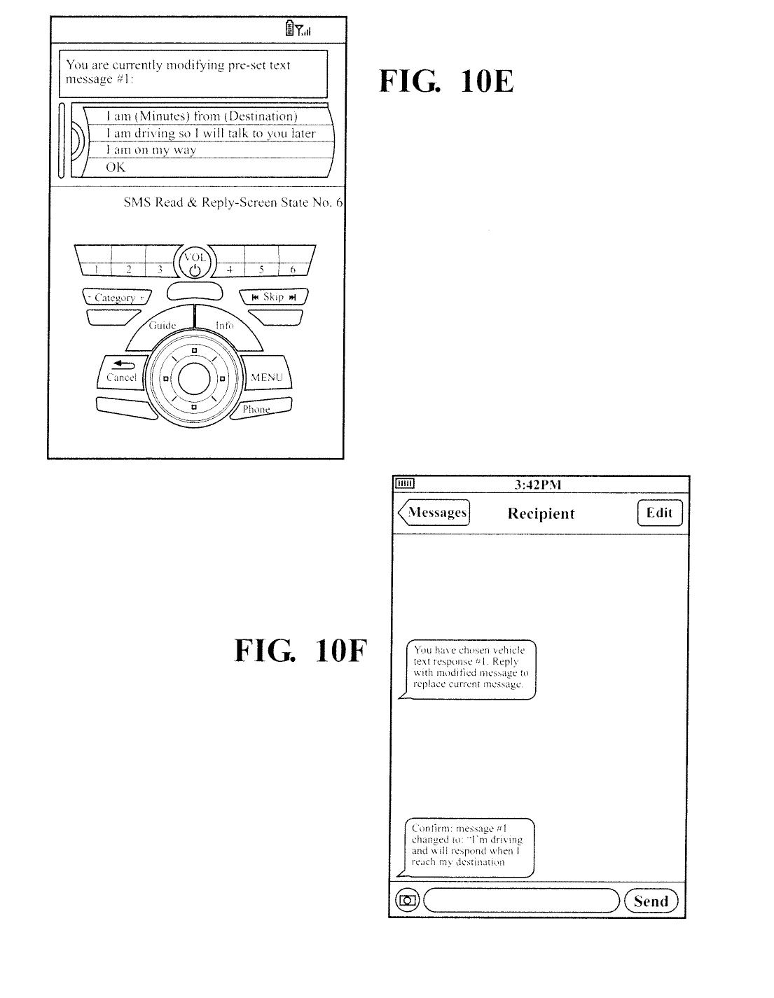

In still another embodiment of the invention, a utility (i.e. software) is provided to the user for loading onto a personal computer in step 700 (FIG. 9). Alternatively, the utility may be accesses via a link on the browser of the PC, or provided in any other way appreciated in the art. Once the utility is loaded on the personal computer, the user accesses it to modify and/or create new messages or preference data in a manner similar to the web page or mobile application embodiments. Upon entry of the data, it may be stored on a recordable media (such as a USB flash drive), sent via a network (wireless or wired), etc. where the data in control system 106 is updated and configured as described in the previous embodiments.

### Responding to Received Messages

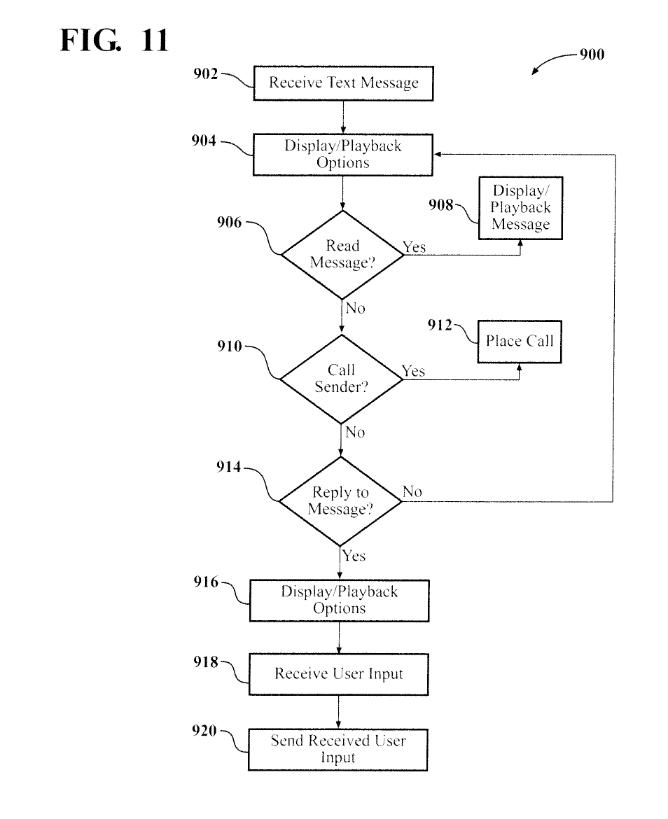

FIG. 11 is an exemplary flow diagram of a method of responding to a received message. The system provides a user (e.g. driver of the vehicle) the ability to quickly reply to messages received on the remote source 116a-c using previously created (i.e. “canned”) responses. For example, a text message may be received (step 902) by a remote device (e.g., PDA, cell phone, etc.) coupled to or connected to a vehicle control system, for example, control system 106. The control system may display and/or playback options (e.g., using the display system and/or audio output system) relating to responding to the text message at step 904. The options may include, but are not limited to, reading the message (e.g., displaying and/or playing back the message for a user of the vehicle), ignoring the message, and replying to the message (e.g., via an audible or tactile input). Alternatively, the system may be set to automatically respond to an incoming message, such that distraction of the driver is minimized.

If the user selects to read the message (step 906), the message may be displayed on a display system (e.g., display system 108) and/or played back on an audio system for the user (step 908). The audio system may use a text-to-speech device to configure the text message into an audible speech representation for the audio system. If the user selects to reply to the message (step 914), options for the reply message may be displayed or played back on the vehicle control system or the remote source (step 916) and the user may choose an option and the option may be received by the vehicle control system directly or via the remote source (step 918). For example, a list of options may be displayed or played back on the vehicle control system, such as “Yes”, “No”, “I am driving and will respond when I reach my destination”, etc. The user may select a predefined option to send as a reply to the text message. Alternatively, the user may provide the vehicle control system with an audible response via an audio input device, and the vehicle control system may use a speech recognition device to convert the input into a text message to send as a reply to the text message. The reply may then be sent to the sender of the original text message using the hands-free phone operation or other method (step 920).

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method of modifying data in a communication system of a vehicle for replying to a received message, the communication system including a control system and a remote source, the method comprising:
pairing the control system and the remote source;
sending a message to the remote source including a request to update data stored for use by the control system;
receiving a response from the remote source in response to the request electing to update the data in the control system;
updating the data in the control system in accordance with the received response, wherein the updating the data step includes predefining a plurality of replies for replying to a received message by the remote source after the data in the control system is updated; and
selecting one of the plurality of replies to send as a reply to the received message by the remote source.

2. The method of claim 1, wherein the control system:
receives a command sent by the remote source initiating modification of data,
detects the command and responds to the remote source by sending the message including the request to update data.

3. The method of claim 2, wherein the message sent to the remote source includes a link to the request to update data.

4. The method of claim 3, wherein accessing the link by the remote source provides an interface for updating the data in the control system.

5. The method of claim 1, wherein the message sent to the remote source includes an application or link to download an application for use by the remote source, and
the application provides an interface for updating the data in the control system using the remote source.

6. The method of claim 1, wherein the remote source is a personal computer connected to the control system via a network, and the personal computer includes software providing an interface for updating the data in the control system.

7. The method of claim 1, wherein the message and response is at least one of a text message, picture message, video message, email message and multi-media message.

8. The method of claim 1, wherein the received message by the remote source is at least one of a text message, picture message, video message, email message and multi-media message, and the data stored in the control system is selected for replying thereto.

9. The method of claim 1, wherein the reply to the received message by the remote source is automatic.

10. The method of claim 1, wherein communication between the control system and the remote source includes one of: a USB connection, a Bluetooth connection, a Wifi connection, and 802.11 connection, an Internet connection, and a network connection.

11. A control system for a vehicle storing data and enabling modification of the stored data for replying to a received message using a remote source, comprising:
a module to pair the control system with the remote source; and
a communication interface sending a message to the remote source including a request to update data stored for use by the control system, and receiving a response from the remote source in response to the request electing to update the data in the control system, wherein
the module updates the data in the control system in accordance with the received response by predefining a plurality of replies for replying to the received message by the remote source after the data in the control system is updated, and a user selects one of the plurality of replies to send as a reply to the received message by the remote source.

12. The system of claim 11, wherein the control system:
receives a command sent by the remote source initiating modification of data,
detects the command and responds to the remote source by sending the message including the request to update data.

13. The system of claim 12, wherein the message sent to the remote source includes a link to the request to update data.

14. The system of claim 13, wherein accessing the link by the remote source provides an interface for updating the data in the control system.

15. The system of claim 11, wherein the message sent to the remote source includes an application or link to download an application for use by the remote source, and
the application provides an interface for updating the data in the control system using the remote source.

16. The system of claim 11, wherein the remote source is a personal computer connected to the control system via a network, and the personal computer includes software providing an interface for updating the data in the control system.

17. The system of claim 11, wherein the message is at least one of a text message, picture message, video message, email message and multi-media message.

18. The system of claim 11, wherein the received message by the remote source is at least one of a text message, picture message, video message, email message and multi-media message, and the data stored in the control system is selected for replying thereto.

19. The system of claim 11, wherein the reply to the received message by the remote source is automatic.

20. The system of claim 11, wherein communication between the control system and the remote source includes one of: a USB connection, a Bluetooth connection, a Wifi connection, and 802.11 connection, an Internet connection, and a network connection.
